(19) United States
(12) Patent Application Publication
(10) Pub. No.: US 2007/0037529 A1
(43) Pub. Date: Feb. 15, 2007

(54) Radio tag communication apparatus

(75) Inventors: Takuya Nagai, Nagoya-shi (JP); Yuji Kiyohara, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 11/584,507

(22) Filed: Oct. 23, 2006

Related U.S. Application Data
(63) Continuation-in-part of application No. PCT/JP05/05498, filed on Mar. 25, 2005.

(30) Foreign Application Priority Data
Apr. 22, 2005 (JP) 2004-126327
May 11, 2004 (JP) 2004-141144

(51) Int. Cl. H04B 1/02; H04Q 5/22

(52) U.S. Cl. 455/101; 343/726; 340/10.34

(57) ABSTRACT

A radio tag communication apparatus having a broad communicable range and a simple arrangement, is provided. Since there are provided a transmission antenna selection control portion for selecting a single transmission-reception antenna element to transmit a transmission signal, from a plurality of transmission-reception antenna elements, and a reception signal synthesizing portion for synthesizing respective reception signals received by the plurality of transmission-reception antenna elements, with each other, a communicable range of the radio tag communication apparatus can be broadened by transmitting the transmission signal from a diversity antenna having a simple arrangement, and a reception sensitivity of the radio tag communication apparatus can be enhanced by synthesizing the reception signals received by the plurality of transmission-reception antenna elements, with each other.

The present application is a continuation-in-part application derived from a national phase of an international patent application PCT/JP2005/005498 filed on Mar. 25, 2005, the contents of which are incorporated herein by reference.

### BACKGROUND OF THE INVENTION

1. Field of the Invention

The present invention relates to a radio tag communication apparatus that communicates with a radio tag in and from which information can be written and read by radio, and particularly to the art of broadening a communicable range of the radio tag communication apparatus.

2. Related Art Statement

There is known an RFID (radio frequency identification) system including a radio tag (i.e., a transponder) that has certain information stored therein, and a radio tag communication apparatus that reads, by radio, the information from the radio tag. Even if the radio tag may be stained, or located at an invisible place, the radio tag communication apparatus can communicate with the radio tag and read out the information stored therein. Thus, the RFID system is expected to find its broad applications in various fields such as merchandise management or product inspection.

In addition, there has been proposed the art of broadening a communicable range of a radio tag communication apparatus. For example, Japanese Patent Application Publication No. 5-128289 discloses a millimeter-wave-using information reading system. This system employs an array antenna that is constituted by a plurality of antenna elements and is commonly used to transmit and receive signals, and can broaden its communicable range by controlling respective phases of respective transmission signals to be transmitted by the antenna elements and controlling respective phases of respective reception signals received by the antenna elements, i.e., performing a phased array control with respect to both the signal transmission and the signal reception.

However, the above-indicated conventional system has drawbacks that its construction is complicated and its production cost is considerably high. Thus, there is a demand for a radio tag communication apparatus that has a broad communicable range and a simple construction. In addition, the conventional system controls its signal-transmission directivity and its signal-reception directivity to coincide with each other, i.e., performs a considerably strong directivity control. Therefore, when a radio tag communication apparatus and a radio tag communicate with each other while they are moving relative to each other, it is possible that the radio tag may go out of the communicable range of the communication apparatus and accordingly the communication between the communication apparatus and the radio rag may fail. In addition, when a radio tag as a communication target or destination, and another radio tag that is not as the communication destination but outputs a considerably strong return signal are present in a same direction, it is possible that a return signal from the radio tag as the communication destination may be mixed up with the strong return signal. Thus, there has not been developed such a radio tag communication apparatus that can well communicate with a radio tag as a communication destination, irrespective of a relative-positional relationship between them or a communication environment around them.

### SUMMARY OF THE INVENTION

It is therefore an object of the present invention to provide a radio tag communication apparatus that can well communicate with a radio tag as a communication destination. It is another object of the present invention to provide a radio tag communication apparatus that has a broad communicable range and/or a simple construction.

The above object has been achieved by the present invention. According to a first aspect of the present invention, there is provided a radio tag communication apparatus for communicating information with a radio tag, comprising a plurality of transmission antenna elements which transmit a transmission signal toward the radio tag; a plurality of reception antenna elements each of which receives, as a reception signal, a return signal returned by the radio tag in response to the transmission signal; a transmission antenna selection control portion which selects one of the transmission antenna elements so that the selected one transmission antenna element transmits the transmission signal toward the radio tag; and a reception signal synthesizing portion which synthesizes the respective reception signals received by the reception antenna elements, with each other.

Thus, the radio tag communication apparatus in accordance with the first aspect of the present invention employs the transmission antenna selection control portion which selects one of the transmission antenna elements so that the selected one transmission antenna element transmits the transmission signal toward the radio tag, and the reception signal synthesizing portion which synthesizes the respective reception signals received by the reception antenna elements, with each other. That is, the radio tag communication apparatus can enjoy a broadened communicable range or space by transmitting the transmission signal from the diversity antenna having the simple arrangement, and can enjoy an increased signal-reception sensitivity by synthesizing the respective reception signals received by the plurality of reception antenna elements, with each other. Thus, the present radio tag communication apparatus can enjoy the broad communicable range and the simple arrangement.

According to a preferred feature of the first aspect of the present invention, the radio tag communication apparatus further comprises a phased array control portion which determines a reception directivity by controlling respective phases of the respective reception signals received by the reception antenna elements. Thus, the radio tag communication apparatus can enjoy the improved signal-reception sensitivity.

According to another preferred feature of the first aspect of the present invention, the transmission antenna selection control portion selects the one transmission antenna element according to the reception directivity determined by the phased array control portion. In this case, since the transmission antenna element selected to transmit the transmission signal is present in a direction corresponding to the reception directivity determined by the phased array control portion, the radio tag communication apparatus can enjoy the widened communicable range.

According to another preferred feature of the first aspect of the present invention, the radio tag communication apparatus further comprises an adaptive array control portion which controls respective weights given to the respective reception signals received by the reception antenna elements. Thus, the radio tag communication apparatus can enjoy the highest possible signal-reception sensitivity.

According to another preferred feature of the first aspect of the present invention, the adaptive array control portion determines, according to the one transmission antenna element selected by the transmission antenna selection control portion, respective initial values of the respective weights given to the respective reception signals received by the reception antenna elements. Thus, under the control of the adaptive array control portion, the respective initial values of the respective weights can be determined according to the communicable range, and accordingly the respective weights can be converged to respective convergent values as quickly as possible.

According to another preferred feature of the first aspect of the present invention, the reception signal synthesizing portion selectively synthesizes the respective reception signals received by the reception antenna elements, with each other. Thus, the radio tag communication apparatus can enjoy a simpler construction.

According to another preferred feature of the first aspect of the present invention, the radio tag communication apparatus further comprises a position detecting portion which detects, based on an amount of the reception signals synthesized by the reception signal synthesizing portion, a position of the radio tag as a communication target. Thus, the radio tag communication apparatus can easily detect the position of the radio tag as the communication destination.

According to another preferred feature of the first aspect of the present invention, the plurality of transmission antenna elements and the plurality of reception antenna elements comprise a plurality of transmission and reception antenna elements which transmit the transmission signal toward the radio tag and each of which receives, as the reception signal, the return signal returned by the radio tag in response to the transmission signal. Thus, the radio tag communication apparatus can enjoy the smallest possible size.

According to another preferred feature of the first aspect of the present invention, the transmission antenna selection control portion selects one of the transmission and reception antenna elements so that the selected one transmission and reception antenna element transmits the transmission signal and the reception signal synthesizing portion synthesizes the respective reception signals received by the one transmission and reception antenna element selected by the transmission antenna selection control portion and at least one of the other transmission and reception antenna elements that is located within a first predetermined distance range from the one transmission and reception antenna element. Thus, a necessary and sufficient number of transmission-reception antenna elements can be used to receive the return signal with an increased sensitivity.

According to another preferred feature of the first aspect of the present invention, the transmission antenna selection control portion selects one of the transmission and reception antenna elements so that the selected one transmission and reception antenna element transmits the transmission signal, and the reception signal synthesizing portion synthesizes the respective reception signals received by not the one transmission and reception antenna element selected by the transmission antenna selection control portion but two or more of the other transmission and reception antenna elements that are located within a second predetermined distance range from the one transmission and reception antenna element. Thus, a necessary and sufficient number of transmission-reception antenna elements can be used to receive the return signal with an increased sensitivity. In addition, since the reception signals can be easily discriminated from the transmission signal, the radio tag communication apparatus can enjoy a simpler construction.

According to a second aspect of the present invention, there is provided a radio tag communication apparatus for communicating information with a radio tag, comprising a plurality of transmission antenna elements which transmit respective transmission signals toward the radio tag; a plurality of reception antenna elements each of which receives, as a reception signal, a return signal returned by the radio tag in response to at least one of the transmission signals; a transmission control portion which controls a transmission directivity by controlling respective phases of the respective transmission signals to be transmitted by the transmission antenna elements; a reception control portion which controls a reception directivity by controlling respective phases of the respective reception signals received by the reception antenna elements; and a reception quality detecting portion which detects a quality of the reception signals controlled by the reception control portion, wherein at least one of the transmission control portion and the reception control portion controls, based on the quality of the reception signals detected by the reception quality detecting portion, a corresponding one of the transmission directivity and the reception directivity.

Thus, the radio tag communication apparatus in accordance with the second aspect of the present invention employs the transmission control portion which controls the transmission directivity by controlling the respective phases of the respective transmission signals to be transmitted by the transmission antenna elements; the reception control portion which controls the reception directivity by controlling the respective phases of the respective reception signals received by the reception antenna elements; and the reception quality detecting portion which detects the quality of the reception signals controlled by the reception control portion, and at least one of the transmission control portion and the reception control portion controls, based on the quality of the reception signals detected by the reception quality detecting portion, a corresponding one of the transmission directivity and the reception directivity. Thus, even in the case where the present radio tag communication apparatus communicates information with the radio tag that is moving relative to the apparatus, or in the case where there is a considerably strong return signal from another radio tag different from the radio tag as the communication target or destination, the present apparatus can control the transmission directivity and/or the reception directivity, and thereby perform good communication with the radio tag as the target. Thus, the present radio tag communication apparatus can well communicate with the radio tag as the target, irrespective of the relative-positional relationship between them or the communication environment around them.

According to a preferred feature of the second aspect of the present invention, each of the transmission control portion and the reception control portion controls, based on the quality of the reception signals detected by the reception quality detecting portion, a corresponding one of the transmission directivity and the reception directivity, independent of an other of the transmission control portion and the reception control portion. Thus, the present apparatus can control the transmission directivity and the reception directivity, independent of each other, and thereby perform good communication with the radio tag as the target.

According to another preferred feature of the second aspect of the present invention, the transmission control portion controls the transmission directivity by controlling respective amplitudes of the respective transmission signals to be transmitted by the transmission antenna elements, and the reception control portion controls the reception directivity by controlling respective amplitudes of the respective reception signals received by the reception antenna elements. Thus, the transmission control portion can reliably determine the transmission directivity, and the reception control portion can reliably determine the reception directivity.

According to another preferred feature of the second aspect of the present invention, the transmission antenna elements and the reception antenna elements comprise at least one transmission and reception antenna element which transmits a transmission signal toward the radio tag and receives, as a reception signal, a return signal returned by the radio tag. Therefore, the size of the present radio tag communication apparatus can be reduced.

According to another preferred feature of the second aspect of the present invention, the transmission antenna elements and the reception antenna elements consist of a plurality of transmission and reception antenna elements each of which transmits a transmission signal toward the radio tag and receives, as a reception signal, a return signal returned by the radio tag. Thus, the size of the present radio tag communication apparatus can be minimized.

According to another preferred feature of the second aspect of the present invention, the reception quality detecting portion detects, as the quality of the reception signals, an error rate of the reception signals. Therefore, the transmission directivity and/or the reception directivity can be controlled based on the error rate of the reception signal that indicates the presence of jamming wave, or a wave reflected by a wall, in the communication environment.

According to another preferred feature of the second aspect of the present invention, the reception quality detecting portion detects, as the quality of the reception signals, a strength of the reception signals. Thus, the transmission directivity and/or the reception directivity can be controlled based on the strength of the reception signal that indicates the relative-positional relationship between the radio tag communication apparatus and the radio rag as the communication target.

According to another preferred feature of the second aspect of the present invention, the transmission control portion controls, when the error rate of the reception signals detected by the reception quality detecting portion is not smaller than a first predetermined value and the strength of the reception signals detected by the reception quality detecting portion is smaller than a second predetermined value, the transmission directivity to be broader. Therefore, for example, in the case where the radio tag as the communication target is moving relative to the radio tag communication apparatus, the transmission directivity is broadened, i.e., the signal transmission range is broadened, and accordingly a good communication is established between the two elements.

According to another preferred feature of the second aspect of the present invention, the transmission control portion controls, when the error rate of the reception signals detected by the reception quality detecting portion is not smaller than a third predetermined value and the strength of the reception signals detected by the reception quality detecting portion is not smaller than a fourth predetermined value, the transmission directivity to be narrower. Therefore, for example, in the case where there is a reflection signal, i.e., the transmission signal reflected from a wall, the transmission directivity is narrowed, i.e., the signal transmission range is narrowed, and accordingly a good communication is established between the two elements.

According to another preferred feature of the second aspect of the present invention, the reception control portion controls, when the error rate of the reception signals detected by the reception quality detecting portion is not greater than a fifth predetermined value, the reception directivity to be equal to the transmission directivity controlled by the transmission control portion. Since the transmission directivity optimized by the transmission control portion can be utilized by the reception control portion, a better communication is established between the two elements.

### BRIEF DESCRIPTION OF THE DRAWINGS

The above and optional objects, features, and advantages of the present invention will be better understood by reading the following detailed description of the preferred embodiments of the invention when considered in conjunction with the accompanying drawings, in which:

FIG. 1 is a view for explaining an arrangement of a communication system including a radio tag communication apparatus as a first embodiment of the present invention, and a radio tag;

FIG. 2 is a view for explaining an electrical arrangement of the radio tag communication apparatus of FIG. 1;

FIG. 3 is a diagrammatic view for explaining a circuit of the radio tag of FIG. 1;

FIG. 4 is a view for explaining respective signal transmission ranges within which a plurality of transmission-reception antenna elements of the radio tag communication apparatus of FIG. 2 can transmit signals;

FIG. 5 a view for explaining a signal transmission pattern and a signal reception pattern of the transmission-reception antenna elements arranged as shown in FIG. 4, more specifically described, a signal transmission pattern of one transmission-reception antenna element selected by a transmission antenna selection control portion, indicated by a thick one-dot chain line, and a signal reception pattern determined by a reception directivity control portion, indicated by a thick solid line;

FIG. 6 is a flow chart for explaining a RFID (radio frequency identification) communication between a control device of the radio tag communication apparatus of FIG. 2 and the radio tag of FIG. 3;

FIG. 7 is a view showing a second embodiment of the present invention in which three transmission-reception antenna elements of another radio tag communication apparatus extend parallel to each other and are provided on a common plane;

FIG. 8 a view for explaining a signal transmission pattern and a signal reception pattern of the transmission-reception antenna elements arranged as shown in FIG. 7, more specifically described, a signal transmission pattern of one transmission-reception antenna element selected by a transmission antenna selection control portion, indicated by a thick one-dot chain line, and a signal reception pattern determined by a reception directivity control portion, indicated by a thick solid line;

FIG. 9 is a view for explaining an electrical arrangement of another radio tag communication apparatus as a third embodiment of the present invention;

FIG. 10 is a view for explaining respective signal transmission ranges within which a plurality of transmission-reception antenna elements of the radio tag communication apparatus of FIG. 9 can transmit signals;

FIG. 11 a view for explaining a signal transmission pattern and a signal reception pattern of the transmission-reception antenna elements arranged as shown in FIG. 10, more specifically described, a signal transmission pattern of one transmission-reception antenna element selected by a transmission antenna selection control portion, indicated by a thick one-dot chain line, and a signal reception pattern determined by a reception directivity control portion, indicated by a thick solid line;

FIG. 12 is a view for explaining an electrical arrangement of another radio tag communication apparatus as a fourth embodiment of the present invention;

FIG. 13 is a view for explaining a directivity pattern established by each of a transmission control portion and a reception control portion of a control device of the radio tag communication apparatus of FIG. 12;

FIG. 14 a view for explaining a directivity pattern suitable for the case where a radio tag as a communication destination is moving relative to a plurality of transmission-reception antenna elements of the radio tag communication apparatus of FIG. 12;

FIG. 15 a view for explaining a directivity pattern suitable for the case where a reflector that can reflect a transmission signal and/or a return signal is present in the vicinity of the radio tag as the communication destination of the radio tag communication apparatus of FIG. 12; and

FIG. 16 is a flow chart for explaining a transmission-reception directivity control carried out in a communication of a control device of the radio tag communication apparatus of FIG. 12 with the radio tag.

### DETAILED DESCRIPTION OF PREFERRED EMBODIMENTS

Hereinafter, there will be described preferred embodiments of the present invention in detail by reference to the drawings.

EMBODIMENT 1

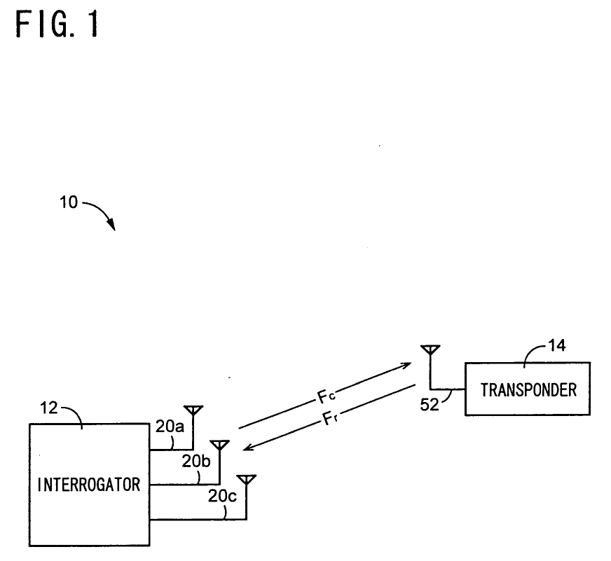

FIG. 1 is a view for explaining an arrangement of a communication system 10 to which the present invention is applied. The communication system 10 is a so-called RFID (radio frequency identification) system, and includes a radio tag communication apparatus 12 as an embodiment of the present invention, and a single, or a plurality of, radio tags 14 (a single radio tag 14 is shown in FIG. 1). The radio tag communication apparatus 12 functions as an interrogator of the RFID system 10, and the radio tag 14 functions as a transponder of the same 10. More specifically described, if the radio tag communication apparatus 12 transmits an interrogator wave (i.e., a transmission signal), Fc, toward the radio tag 14, then the radio tag 14 receives the interrogator wave Fc, modulates, based on an information signal (i.e., “data”), the received interrogator wave Fc, and returns the modulated interrogator wave Fc as a transponder wave (i.e., a return signal), Fr, toward the radio tag communication apparatus 12. Thus, the radio tag communication apparatus 12 and the radio tag 14 communicate information (i.e., “data”) with each other.

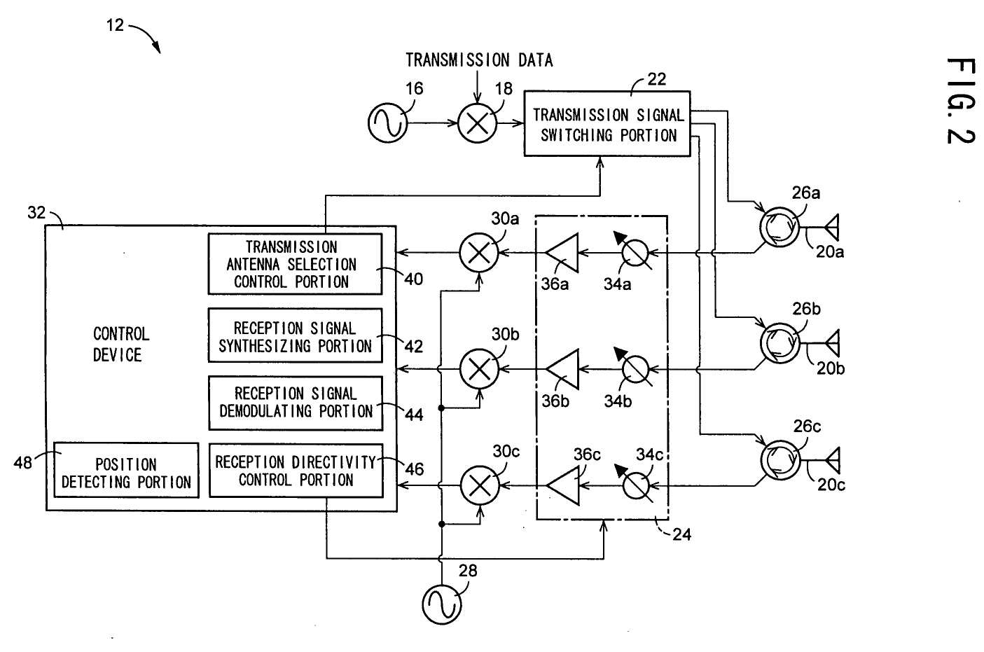

FIG. 2 is a view for explaining an electrical arrangement of the radio tag communication apparatus 12. As shown in the FIG., the radio tag communication apparatus 12 includes a main carrier wave generating portion 16 that generates a main carrier wave for the above-mentioned transmission signal; a transmission signal generating portion 18 that generates the transmission signal by synthesizing the main carrier wave generated by the main carrier wave generating portion 16, with a transmission information signal generated by a transmission data generating portion 108, described later; a plurality of (e.g., three) transmission-reception antenna elements 20a, 20b, 20c (hereinafter, simply referred to as the “transmission-reception antenna elements 20” unless they need to be discriminated from each other) each of which can transmit the transmission signal generated by the transmission signal generating portion 18, toward the radio tag 14, and can receive the return signal returned by the radio tag 14 in response to the transmission signal; a transmission signal switching portion 22 that switches the circuit so as to supply the transmission signal generated by the transmission signal generating portion 18, to a selected one of the plurality of transmission-reception antenna elements 20; a phase-amplitude control portion 24 that controls respective phases and respective amplitudes of respective reception signals received by the plurality of transmission-reception antenna elements 20; a plurality of (e.g., three) transmission-reception separating portions 26a, 26b, 26c (hereinafter, simply referred to as the “transmission-reception separating portions 26” unless they need to be discriminated from each other) each of which supplies the transmission signal supplied by the transmission signal switching portion 22, to a corresponding one of the transmission-reception antenna elements 20, and supplies the reception signal received by the corresponding transmission-reception antenna element 20, to the phase-amplitude control portion 24; a local oscillator 28 that generates a local oscillator signal having a predetermined frequency; a plurality of (e.g., three) down-converters 30a, 30b, 30c (hereinafter, simply referred to as the “down-converters 30” unless they need to be discriminated from each other) each of which multiplies, by the local oscillator signal generated by the local oscillator 28, a corresponding one of the respective reception signals the phases and amplitudes of which have been controlled by the phase-amplitude control portion 24, and thereby down-converts the corresponding reception signal; and a control device 32 that controls operations of the radio tag communication apparatus 12, including processing of the reception signal down-converted by the each down-converter 30. More specifically described, each of the transmission-reception antenna elements 20 is preferably provided by a bar-like antenna element such as a dipole antenna. In addition, each of the transmission-reception separating portions 26 is preferably provided by a circulator or a directional coupler. Moreover, the phase-amplitude control portion 24 includes a plurality of (e.g., three) phase control portions 34a, 34b, 34c (hereinafter, simply referred to as the “phase control portions 34” unless they need to be discriminated from each other) each of which controls the phase of the reception signal received by a corresponding one of the transmission-reception separating portions 26; and a plurality of (e.g., three) amplitude control portions 36a, 36b, 36c(hereinafter, simply referred to as the “amplitude control portions 36” unless they need to be discriminated from each other) each of which controls the amplitude of the reception signal received by a corresponding one of the transmission-reception separating portions 26. Thus, each of the phase control portions 34 controls the phase of the reception signal received by a corresponding one of the transmission-reception antenna elements 20; and each of the amplitude control portions 36 controls the amplitude of the reception signal received by a corresponding one of the transmission-reception antenna elements 20.

The control device 32 is provided by a so-called microcomputer including a CPU (central processing unit), a ROM (read only memory), and a RAM (random access memory), and processes signals according to control programs pre-stored by the ROM while utilizing a temporary-storage function of the RAM. More specifically described, the control device 32 controls RFID communications of the radio tag communication apparatus 12 with the radio tag 14. The control device 32 includes, as functions or capabilities thereof the transmission data generating portion 108, a transmission antenna selection control portion 40, a reception signal synthesizing portion 42, a reception signal demodulating portion 44, a reception directivity control portion 46, and a position detecting portion 48.

The transmission data generating portion 108 generates transmission data as the transmission information signal to modulate the transmission signal, and supplies the thus generated transmission information signal to the transmission signal generating portion 18. The transmission antenna selection control portion 40 selects, from the plurality of transmission-reception antenna elements 20, one transmission-reception antenna element 20 to transmit the transmission signal. More specifically described, the transmission antenna selection control portion 40 controls the circuit switching operation of the transmission signal switching portion 22, and thereby controls a transmission antenna constituted by the plurality of transmission-reception antenna elements 20 so that the transmission antenna may function as a transmission diversity antenna. Preferably, the transmission antenna selection control portion 40 can select one transmission-reception antenna element 20 so that the reception signal synthesizing portion 42, described later, may synthesize a maximum amount of the reception signals into a synthesized reception signal. Also, preferably, the transmission antenna selection control portion 40 can select one transmission-reception antenna element 20 according to a reception directivity determined by the reception directivity control portion 46, described later.

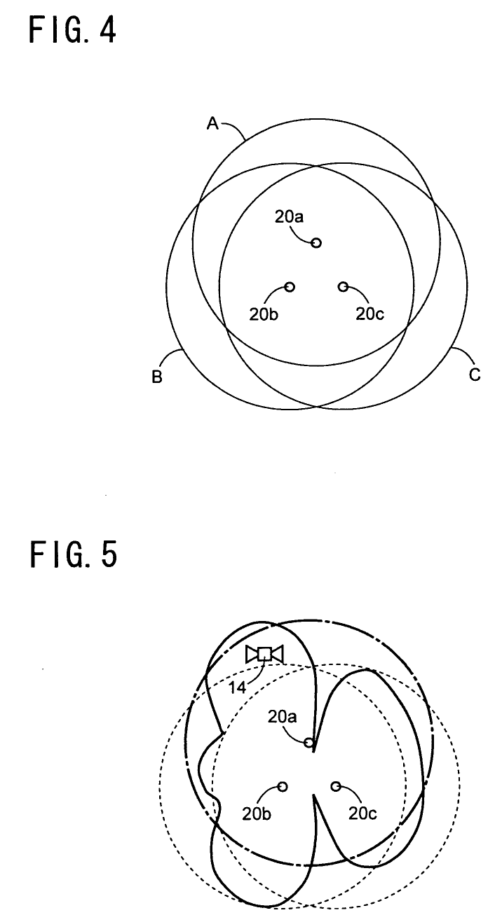

FIG. 4 is a view for explaining respective signal transmission ranges within which the plurality of transmission-reception antenna elements 20 can transmit respective transmission signals. FIG. 4 shows an example in which the three bar-like transmission-reception antenna elements 20a, 20b, 20c extend parallel to each other, and a plane defined by each pair of transmission-reception antenna elements 20 does not contain the remaining transmission-reception antenna element 20 (more specifically described, three planes respectively defined by three pairs of transmission-reception antenna elements 20 contain three 60-degree angles). Generally, a signal transmission range within which a single bar-like antenna element can transmit a transmission signal is a cylindrical space having a centerline on an axis line of the bar-like antenna element. That is, the signal transmission range within which the transmission-reception antenna element 20a can transmit the transmission signal is a cylindrical space, A, having a centerline on an axis line of the antenna element 20a; the signal transmission range within which the transmission-reception antenna element 20b can transmit the transmission signal is a cylindrical space, B, having a centerline on an axis line of the antenna element 20b; and the signal transmission range within which the transmission-reception antenna element 20c can transmit the transmission signal is a cylindrical space, C, having a centerline on an axis line of the antenna element 20c.

FIG. 5 is a view for explaining a signal transmission pattern and a signal reception pattern with respect to the transmission-reception antenna elements 20 arranged as shown in FIG. 4. A thick one-dot chain line indicates the signal transmission pattern, i.e., the signal transmission range of the single transmission-reception antenna element 20a selected by the transmission antenna selection control portion 40; and a thick solid line indicates the signal reception pattern, i.e., the reception directivity determined by the reception directivity control portion 46, described later. For example, in the case where the radio tag 14 as a communication target or destination is located at a position shown in FIG. 5, the radio tag 14 is out of the respective signal transmission ranges of the transmission-reception antenna elements 20b, 20c. Therefore, the respective transmission signals transmitted by those antenna elements 20b, 20c cannot reach, with a sufficiently high strength, the radio tag 14 as the communication destination. However, the radio tag 14 is within the signal transmission range of the transmission-reception antenna element 20a. Therefore, if the transmission antenna selection control portion 40 selects the antenna element 20a, then the transmission signal transmitted by the thus selected antenna element 20a can reach, with a sufficiently high strength, the radio tag 14 as the communication destination.

Back to FIG. 2, the reception signal synthesizing portion 42 synthesizes the respective reception signals received by the plurality of transmission-reception antenna elements 20, with each other, into the synthesized reception signal. Because the reception signal synthesizing portion 42 synthesizes the respective reception signals whose phases have been controlled by the phase-amplitude control portion 24, a reception directivity of a reception antenna constituted by the plurality of transmission-reception antenna elements 20 is determined.

The reception signal demodulating portion 44 demodulates the synthesized reception signal outputted by the reception signal synthesizing portion 42. Preferably, the demodulating portion 44 demodulates, by an AM (amplitude modulation) method, the synthesized reception signal into an AM demodulated signal, and decodes the AM demodulated signal into an FM decoded signal from which an information signal relating to the modulation by the radio tag 14 is read.

The reception directivity control portion 46 determines the reception directivity by controlling the respective phases of the respective reception signals received by the plurality of transmission-reception antenna elements 20. More specifically described, the reception directivity control portion 46 controls the phase-amplitude control portion 24 to control the respective phases of the respective reception signals, and thereby controls, as a reception phased-array antenna, the reception antenna constituted by the plurality of transmission-reception antenna elements 20. Alternatively, the reception directivity control portion 46 controls respective weights to be given to the respective reception signals received by the plurality of transmission-reception antenna elements 20, so that the reception signal synthesizing portion 42 may output an optimum signal. More specifically described, the reception directivity control portion 46 controls the phase-amplitude control portion 24 to control the respective phases and/or amplitudes of the respective reception signals, and thereby controls, as a reception adaptive-array antenna, the reception antenna constituted by the plurality of transmission-reception antenna elements 20. Preferably, the reception directivity control portion 46 determines the reception directivity so that the reception signal synthesizing portion 42 may synthesize a maximum amount of the reception signals. Alternatively, the reception directivity control portion 46 preferably determines, according to one transmission-reception antenna element 20 selected by the transmission antenna selection control portion 40, respective initial values of the respective weights to be given to the respective reception signals received by the plurality of transmission-reception antenna elements 20. For example, in the case where the radio tag 14 as the communication destination is located at the position shown in FIG. 5, the reception directivity control portion 46 determines, as the reception directivity, the signal reception pattern indicated by the thick solid line, so that the return signal returned by the radio tag 14 can be received with a high sensitivity.

Back to FIG. 2, the position detecting portion 48 detects, based on the amount of the reception signals synthesized by the reception signal synthesizing portion 42, a position of the radio tag 14 as the communication destination. Preferably, the position detecting portion 48 detects a direction and a distance of the radio tag 14, based on the position of the one transmission-reception antenna element 20 selected by the transmission antenna selection control portion 40, and the reception directivity determined by the reception directivity control portion 46, each for the purpose of maximizing the amount of the reception signals synthesized by the reception signal synthesizing portion 42, and additionally the strength of the synthesized reception signal outputted by the synthesizing portion 42. The direction and distance of the radio tag 14 may be detected as a relative direction and a relative distance of the radio tag 14 with respect to a coordinate system defined for the plurality of transmission-reception antenna elements 20. Since the transmission and reception directivities determined by the transmission antenna selection control portion 40 and the reception directivity control portion 46 correspond to the relative direction of the radio tag 14 as the communication destination, the relative direction of the radio tag 14 can be estimated based on the transmission and reception directivities. In addition, since the strength of the synthesized reception signal outputted by the reception signal synthesizing portion 42 corresponds to the relative distance of the radio tag 14, the relative distance of the radio tag 14 can be estimated based on the strength of the synthesized reception signal.

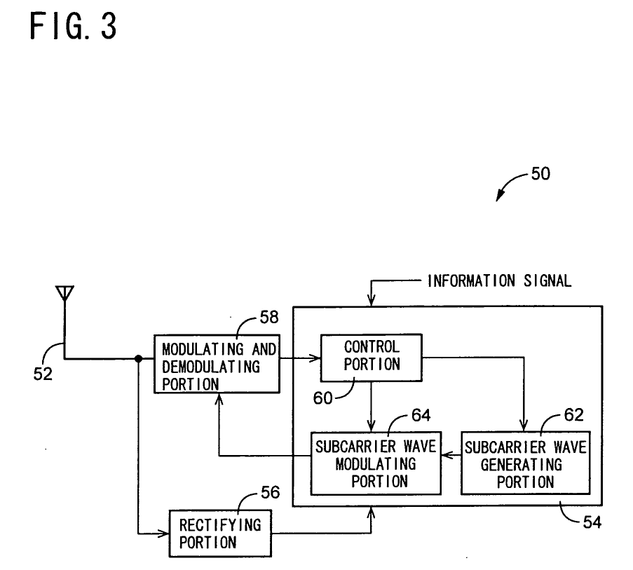

FIG. 3 is a diagrammatic view for explaining a radio tag circuit 50 of the radio tag 14. As shown in FIG. 3, the radio tag 14 receives the transmission signal transmitted by the radio tag communication apparatus 12, and the radio tag circuit 50 includes an antenna 52 that transmits or returns the return signal toward the radio tag communication apparatus 12; a digital circuit portion 54 that processes digital signals; a rectifying portion 56 that rectifies a portion of the transmission signal received by the antenna 52 and supplies, as an energy source, the rectified signal to the digital circuit portion 54; and a modulating and demodulating portion 58 that is connected to the antenna 52 and modulates and demodulates signals. The digital circuit portion 54 includes, as functions or capabilities thereof, a control portion 60 that controls operations of the radio tag circuit 50; a subcarrier generating portion 62 that generates a subcarrier wave; and a subcarrier modulating portion 64 that modulates, based on the information signal inputted via the control portion 60, the subcarrier wave generated by the subcarrier generating portion 62, according to a phase modulation (PSK, phase-shift keying) method. This modulation is a primary modulation. The subcarrier wave modulated by the subcarrier modulating portion 64 of the digital circuit portion 54 is inputted to the modulating and demodulating portion 58, so that the modulating and demodulating portion 58 modulates, based on the subcarrier wave inputted thereto, the transmission signal received from the radio tag communication apparatus 12. This modulation is a secondary modulation. The antenna 52 transmits, as the return signal, the thus modulated transmission signal toward the radio tag communication apparatus 12.

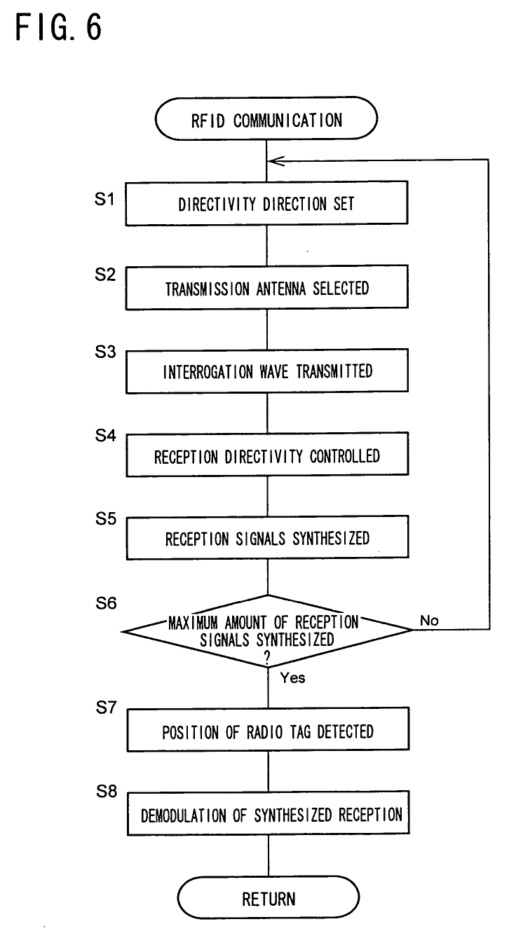

FIG. 6 is a flow chart representing an RFID communication operation of the control device 32 of the radio tag communication apparatus 12. The RFID communication is carried out between the radio tag communication apparatus 12 and the radio tag 14. The RFID communication operation is repeated at a predetermined period or cycle time. Hereinafter, an information communication operation carried out between the radio tag communication apparatus 12 and the radio tag 14 will be described by reference to the flow chart.

First, at Step S1, the control device 32 sets a directivity direction common to signal transmission and signal reception, so as to communicate with a radio tag possibly present in the thus set directivity direction. Then, at Step S2 corresponding to the operation of the transmission antenna selection control portion 40, the control device 32 selects one of the plurality of transmission-reception antenna elements 20 that is to transmit the transmission signal, and controls the transmission signal switching portion 22 to switch the circuit so as to supply the transmission signal to the selected transmission-reception antenna element 20. Subsequently, at Step S3, the control device 32 controls the main carrier wave generating portion 16 to generate the main carrier wave, and controls the transmission signal generating portion 18 to synthesize the main carrier wave with the transmission information signal generated by the transmission data generating portion 108, and thereby generate the transmission signal. In addition, the control device 32 controls the single transmission-reception antenna element 20, selected at Step S2, to transmit the transmission signal toward the radio tag 14. Then, at Step S4 corresponding to the operation of the reception directivity control portion 46, the control device 32 controls respective weights given to the respective reception signals received by the plurality of transmission-reception antenna elements 20, and thereby determines a reception directivity. Preferably, the control device 32 determines, according to the specific transmission-reception antenna element 20 selected at Step S2, respective initial values of the respective weights given to the respective reception signals. Subsequently, at Step S5 corresponding to the operation of the reception signal synthesizing portion 42, the control device 32 synthesizes the respective reception signals received by the plurality of transmission-reception antenna elements 20, with each other, into a synthesized reception signal. Then, at Step S6, the control device 32 judges whether an amount of the reception signals synthesized at Step S5 takes a maximum value. If a negative judgment is made at Step S6, the control of the control device 32 returns to Step S1 and the following steps. On the other hand, if a positive judgment is made at Step S6, the control goes to Step S7 corresponding to the operation of the position detecting portion 48. At Step S7, the control device 32 detects, based on the reception directivity determined by the reception directivity control portion 46 and the amount of the reception signals synthesized by the reception signal synthesizing portion 42, a direction and a distance of the radio tag 14 as the communication destination. Then, at Step S8 corresponding to the operation of the reception signal demodulating portion 44, the control device 32 demodulates the synthesized reception signal produced at Step S5 based on the respective reception signals received by the plurality of transmission-reception antenna elements 20. Thus, one control cycle of this routine is finished.

As is apparent from the foregoing description of the first embodiment, the radio tag communication apparatus 12 includes the transmission antenna selection control portion 40 (Step S2) that selects one of the plurality of transmission-reception antenna elements 20 that is to transmit the transmission signal; and the reception signal synthesizing portion 42 (Step S5) that synthesizes the respective reception signals received by the plurality of transmission-reception antenna elements 20, with each other, into the synthesized reception signal. That is, the radio tag communication apparatus 12 can enjoy a broadened communicable range or space by transmitting the transmission signal with the diversity antenna 20 having the simple arrangement, and can enjoy an increased reception sensitivity by synthesizing the respective reception signals received by the plurality of transmission-reception antenna elements 20. Thus, the radio tag communication apparatus 12 can enjoy the broad communicable range and the simple arrangement.

In addition, the radio tag communication apparatus 12 includes the reception directivity control portion 46 (Step S4) that determines the reception directivity by controlling the respective phases of the respective reception signals received by the plurality of transmission-reception antenna elements 20. Thus, the radio tag communication apparatus 12 can enjoy the increased sensitivity of reception of the reception signals.

In addition, the transmission antenna selection control portion 40 selects one of the plurality of transmission-reception antenna elements 20, according to the reception directivity determined by the reception directivity control portion 46. That is, since the transmission-reception antenna element 20 selected to transmit the transmission signal is present in the direction corresponding to the reception directivity determined by the reception directivity control portion 46, the radio tag communication apparatus 12 can enjoy the broadened communicable range.

In addition, the reception directivity control portion 46 is a phased array control portion that controls the respective phases of the respective reception signals received by the plurality of transmission-reception antenna elements 20. Thus, the radio tag communication apparatus 12 can enjoy the improved sensitivity of reception of the reception signals.

In addition, the reception directivity control portion 46 is an adaptive array control portion that controls the respective weights given to the respective reception signals received by the plurality of transmission-reception antenna elements 20. Thus, the radio tag communication apparatus 12 can enjoy the highest sensitivity of reception of the reception signals.

In addition, the reception directivity control portion 46 determines, according to the single (or specific) transmission-reception antenna element 20 selected by the transmission antenna selection control portion 40, the respective initial values of the respective weights given to the respective reception signals received by the plurality of transmission-reception antenna elements 20. Therefore, under the control of the reception directivity control portion 46, the respective weights are converged to respective convergent values as quickly as possible.

In addition, the radio tag communication apparatus 12 includes the position detecting portion 48 (Step S7) that detects, based on the reception directivity determined by the reception directivity control portion 46 and the amount of the reception signals synthesized by the reception signal synthesizing portion 42, the direction and the distance of the radio tag 14 as the communication destination. Thus, the radio tag communication apparatus 12 can easily detect the position of the radio tag 14 as the communication destination.

In addition, the radio tag communication apparatus 12 includes the plurality of transmission-reception antenna elements 20 that transmit the transmission signal toward the radio tag 14 and receive the return signal returned by the radio tag 14 in response to the transmission signal. Thus, the radio tag communication apparatus 12 can enjoy the smallest size.

EMBODIMENT 2

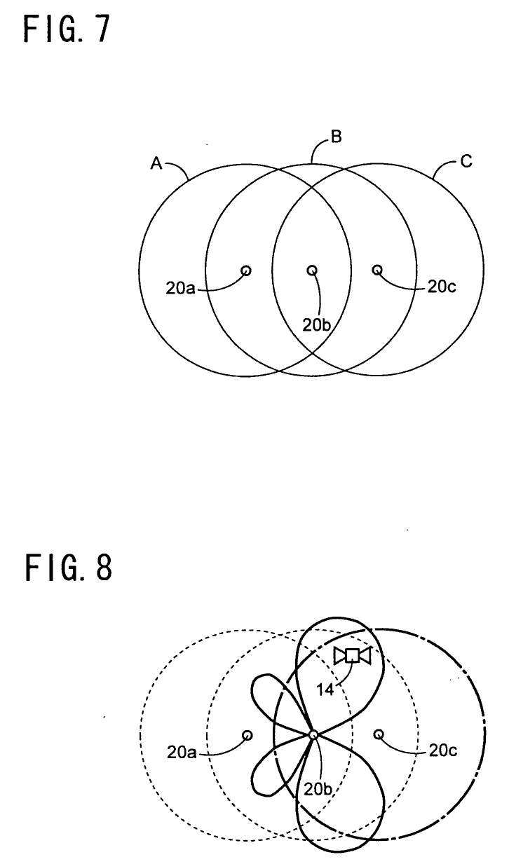

Hereinafter, there will be described a second embodiment of the present invention by reference to FIGS. 7 and 8. The same reference numerals as used in the first embodiment shown in FIGS. 1 through 6 are used to designate the corresponding elements or parts of the second embodiment, and the description thereof is omitted.

FIG. 7 shows the second embodiment in which the three bar-like transmission-reception antenna elements 20a, 20b, 20c extend parallel to each other, and are provided on a common plane. The signal transmission range within which the transmission-reception antenna element 20a can transmit the transmission signal is a cylindrical space, A, having a centerline on an axis line of the antenna element 20a; the signal transmission range within which the transmission-reception antenna element 20b can transmit the transmission signal is a cylindrical space, B, having a centerline on an axis line of the antenna element 20b; and the signal transmission range within which the transmission-reception antenna element 20c can transmit the transmission signal is a cylindrical space, C, having a centerline on an axis line of the antenna element 20c.

FIG. 8 is a view for explaining a signal transmission pattern and a signal reception pattern with respect to the transmission-reception antenna elements 20 arranged as shown in FIG. 7. A thick one-dot chain line indicates the signal transmission pattern, i.e., the signal transmission range of the single transmission-reception antenna element 20c selected by the transmission antenna selection control portion 40; and a thick solid line indicates the signal reception pattern, i.e., the reception directivity determined by the reception directivity control portion 46. For example, in the case where the radio tag 14 as the communication destination is located at a position shown in FIG. 8, the radio tag 14 is out of the signal transmission range of the transmission-reception antenna element 20a. Therefore, the transmission signal transmitted by the antenna element 20a cannot reach, with a sufficiently high strength, the radio tag 14 as the communication destination. However, the radio tag 14 is within the respective signal transmission ranges of the two transmission-reception antenna elements 20b, 20c. Therefore, if the transmission antenna selection control portion 40 selects either one (e.g., the antenna element 20c in FIG. 8) of the two antenna elements 20b, 20c, then the transmission signal transmitted by the thus selected antenna element 20c can reach, with a sufficiently high strength, the radio tag 14 as the communication destination. In addition, since the reception directivity control portion 46 determines, as the reception directivity, the signal reception pattern indicated by the thick solid line, the return signal returned by the radio tag 14 can be received with a high sensitivity.

EMBODIMENT 3

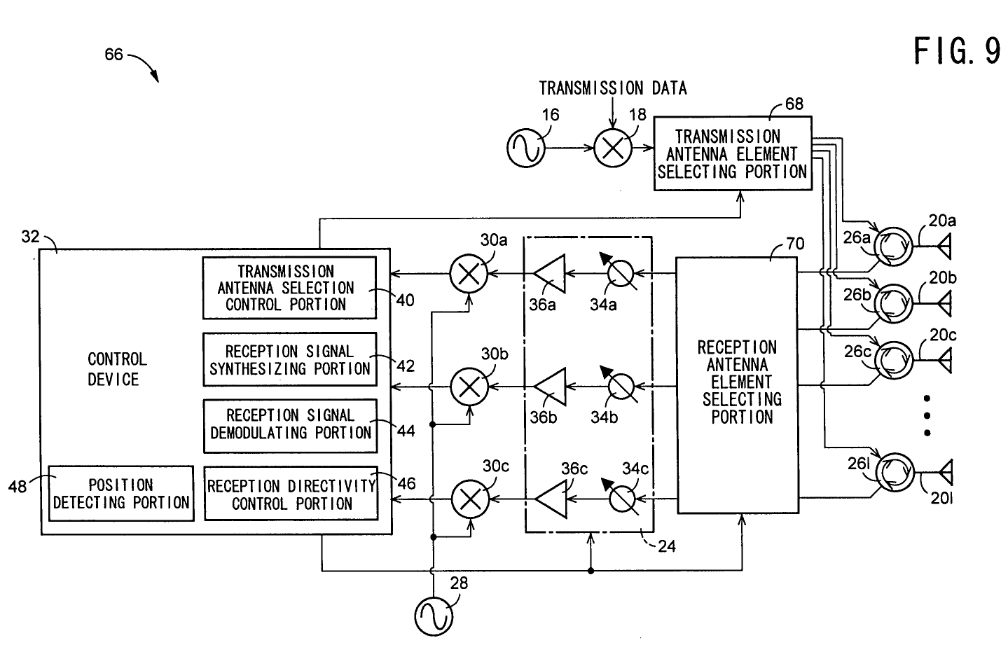

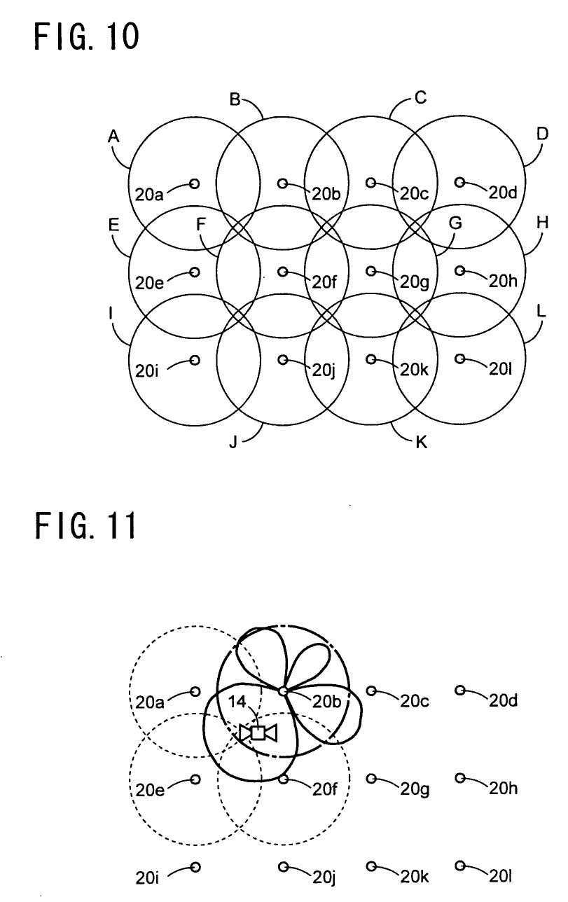

FIG. 9 is a view for explaining an electrical arrangement of a radio tag communication apparatus 66 as a third embodiment of the present invention. As shown in the FIG., the radio tag communication apparatus 66 includes twelve transmission-reception antenna elements 20a, 20b, 20c, . . . , 20l (hereinafter, simply referred to as the transmission-reception antenna elements 20 unless they need to be discriminated from each other) each of which is provided by a bar-like antenna element such as a dipole antenna; a transmission antenna element selecting portion 68 that switches the circuit so as to supply the transmission signal generated by the transmission signal generating portion 18 to one of the twelve transmission-reception antenna elements 20; a reception antenna element selecting portion 70 that switches the circuit so as to supply the respective reception signals received by two or more of the twelve transmission-reception antenna elements 20 to the phase-amplitude control portion 24; and twelve transmission-reception separating portions 26a, 26b, 26c, . . . , 26l (hereinafter, simply referred to as the “transmission-reception separating portions 26” unless they need to be discriminated from each other) each of which supplies the transmission signal supplied by the transmission antenna element selecting portion 70, to a corresponding one of the transmission-reception antenna elements 20, and supplies the reception signal received by the corresponding transmission-reception antenna element 20, to the reception antenna element selecting portion 70. In FIG. 9, the transmission-reception antenna elements 20d through 20k (FIG. 10) and the transmission-reception separating portions 26d through 26k are not shown for simplification purposes only.

The transmission-antenna selection control portion 40 of the control device 32 of the radio tag communication apparatus 66 controls the circuit switching operation of the transmission-antenna-element selecting portion 68, and thereby controls a transmission antenna constituted by the plurality of transmission-reception antenna elements 20 to function as a transmission diversity antenna. In addition, the reception directivity control portion 46 controls the circuit switching operation of the reception antenna element selecting portion 70, so that the respective reception signals received by the twelve transmission-reception antenna elements 20 are selectively supplied (i.e., supplied or not supplied) to the phase-amplitude control portion 24. Thus, the reception signal synthesizing portion 42 synthesizes the selectively supplied reception signals, with each other, into a synthesized reception signal.

FIG. 10 is a view for explaining respective signal transmission ranges within which the twelve transmission-reception antenna elements 20 transmit the respective transmission signals. As shown in FIG. 10, the twelve transmission-reception antenna elements 20 are located at twelve lattice points of a 4×3 lattice, respectively, such that the twelve transmission-reception antenna elements 20 extend parallel to each other. The respective signal transmission ranges within which the twelve transmission-reception antenna elements 20a through 20l can transmit the respective transmission signals are respective cylindrical spaces, A through L, having respective centerlines on respective axis lines of the antenna elements 20a through 20l.

FIG. 11 is a view for explaining a signal transmission pattern and a signal reception pattern with respect to the transmission-reception antenna elements 20 arranged as shown in FIG. 10. A thick one-dot chain line indicates the signal transmission pattern, i.e., the signal transmission range of one transmission-reception antenna element 20b selected by the transmission antenna selection control portion 40; and a thick solid line indicates the signal reception pattern, i.e., the reception directivity determined by the reception directivity control portion 46. For example, in the case where the radio tag 14 as the communication destination is located at a position shown in FIG. 11, the radio tag 14 is out of the respective signal transmission ranges of the transmission-reception antenna elements 20a, 20c through 20e, and 20g through 20l. Therefore, the respective transmission signals transmitted by those antenna elements 20a, 20c through 20e, and 20g through 20l cannot reach, with a sufficiently high strength, the radio tag 14 as the communication destination. However, the radio tag 14 is within the respective signal transmission ranges of the two transmission-reception antenna elements 20b, 20f. Therefore, if the transmission antenna selection control portion 40 selects either one (e.g., the antenna element 20b in FIG. 11) of the two antenna elements 20b, 20f, then the transmission signal transmitted by the antenna element 20b can reach, with a sufficiently high strength, the radio tag 14 as the communication destination.

In addition, the control device 32 of the radio tag communication apparatus 66 carries out a signal receiving operation in which the reception directivity control portion 46 selects, as reception antenna elements, the one transmission-reception antenna element 20b selected by the transmission-antenna selection control portion 40, and one or more antenna elements (e.g., three antenna elements 20a, 20e, 20f in FIG. 11) of the remaining, eleven transmission-reception antenna elements 20 that falls or fall within a first predetermined distance range from the selected one antenna element 20b. More specifically described, the reception directivity control portion 46 controls the reception antenna element selecting portion 70 to switch the circuit so that the respective reception signals received by the thus selected transmission-reception antenna elements 20a, 20b, 20e, 20f are supplied to the phase-amplitude control portion 24 and the reception signal synthesizing portion 42 synthesizes the thus supplied reception signals with each other into a synthesized reception signal. Thus, the signal reception pattern indicated by the thick solid line in FIG. 11 is determined. However, the reception directivity control portion 46 may be modified not to select the one transmission-reception antenna element 20b selected by the transmission-antenna selection control portion 40, but to select, as the reception antenna elements, two or more antenna elements of the remaining, eleven transmission-reception antenna elements 20 that fall within a second predetermined distance range from the selected one antenna element 20b. In this case, only the respective reception signals received by the thus selected transmission-reception antenna elements 20 are supplied to the phase-amplitude control portion 24, and the reception signal synthesizing portion 42 synthesizes the thus supplied reception signals with each other into the synthesized reception signal.

As is apparent from the foregoing description of the third embodiment, the reception signal synthesizing portion 42 synthesizes the respective reception signals received by the selected transmission-reception antenna elements 20. Therefore, the radio tag communication apparatus 66 can enjoy a simple construction.

More specifically described, the reception signal synthesizing portion 42 synthesizes the respective reception signals received by the one transmission-reception antenna element 20 selected by the transmission-antenna selection control portion 40 and the one or more transmission-reception antenna elements 20 that falls or fall within the first predetermined distance range from the selected one antenna element 20. Thus, a necessary and sufficient number of transmission-reception antenna elements 20 can be used to receive the return signal with an increased sensitivity.

Alternatively, the reception signal synthesizing portion 42 synthesizes the respective reception signals received by not the one transmission-reception antenna element 20 selected by the transmission-antenna selection control portion 40 but the two or more transmission-reception antenna elements 20 that fall within the second predetermined distance range from the selected one antenna element 20. Thus, a necessary and sufficient number of transmission-reception antenna elements 20 can be used to receive the return signal with an increased sensitivity. In addition, the reception signals can be easily discriminated from the transmission signal.

EMBODIMENT 4

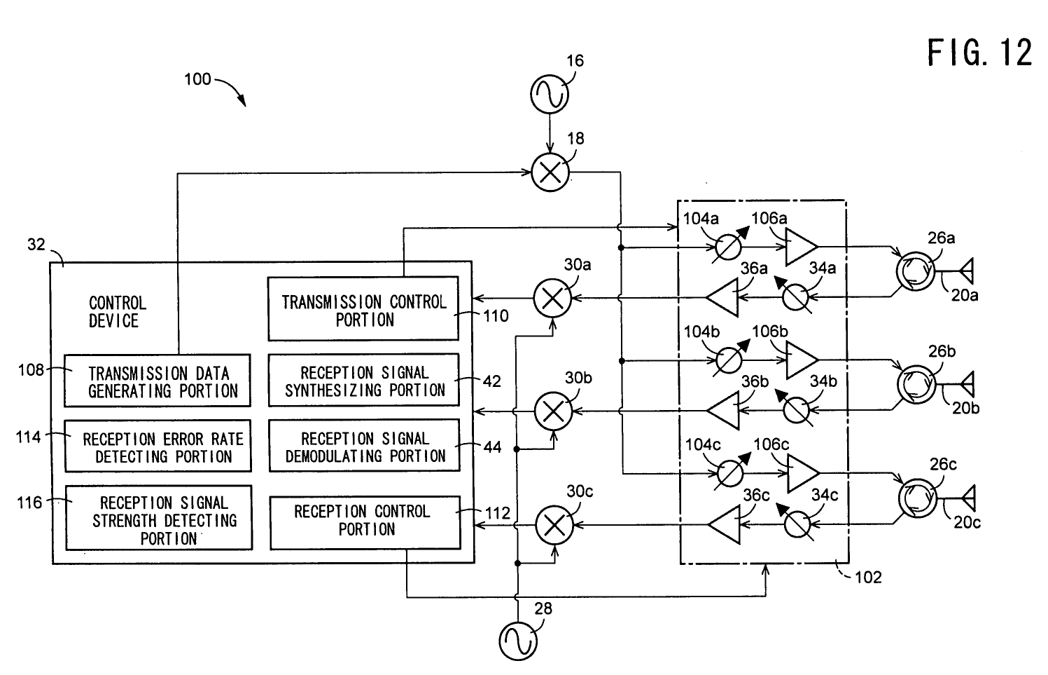

FIG. 12 is a view for explaining an electrical arrangement of a radio tag communication apparatus 100 as a fourth embodiment of the present invention. As shown in FIG. 12, the radio tag communication apparatus 100 includes a directivity control portion 102 that controls not only a transmission directivity, i.e., a directivity of the respective transmission signals transmitted by the plurality of transmission-reception antenna elements 20 but also a reception directivity, i.e., a directivity of the respective reception signals received by the same 20.

The directivity control portion 102 includes a plurality of (e.g., three) transmission-signal phase control portions 104a, 104b, 104c (hereinafter, simply referred to as the “transmission-signal phase control portions 104” unless they need to be discriminated from each other) each of which controls a phase of the transmission signal supplied from the transmission-signal generating portion 18; and a plurality of (e.g., three) transmission-signal amplitude control portions 106a, 106b, 106c (hereinafter, simply referred to as the “transmission-signal amplitude control portions 106” unless they need to be discriminated from each other) each of which controls an amplitude of the transmission signal. Since the transmission-signal phase control portions 104 and the transmission-signal amplitude control portions 106 control the respective phases and amplitudes of the respective transmission signals transmitted by the plurality of transmission-reception antenna elements 20, the directivity of the respective transmission signals is controlled. In addition, the directivity control portion 102 includes a plurality of (e.g., three) reception-signal phase control portions 34a, 34b, 34c (hereinafter, simply referred to as the “reception-signal phase control portions 34” unless they need to be discriminated from each other) each of which controls a phase of the reception signal received by a corresponding one of the transmission-reception separating portions 26; and a plurality of (e.g., three) reception-signal amplitude control portions 36a, 36b, 36c (hereinafter, simply referred to as the “reception-signal amplitude-control portions 36” unless they need to be discriminated from each other) each of which controls an amplitude of the reception signal received by a corresponding one of the transmission-reception separating portions 26. Since the reception-signal phase control portions 34 and the reception-signal amplitude control portions 36 control the respective phases and amplitudes of the respective reception signals received by the plurality of transmission-reception antenna elements 20, the directivity of the respective reception signals is controlled.

The control device 32 is provided by a so-called microcomputer including a CPU, a ROM, and a RAM, and processes signals according to control programs pre-stored by the ROM while utilizing a temporary-storage function of the RAM. Thus, the control device 32 generates transmission data, determines respective control amounts of the transmission-signal phase control portions 104 and the transmission-signal amplitude control portions 106, determines respective control amounts of the reception-signal phase control portions 34 and the reception-signal amplitude control portions 36, controls the transmission of the transmission signal toward the radio tag 14, controls the reception of the return signal from the radio tag 14 in response to the transmission signal, controls the demodulation of the synthesized reception signal, and controls the detection of quality of the reception signals. To carry out those operations, the control device 32 includes, as functions or capabilities thereof, the above-described reception signal synthesizing portion 42 and reception signal demodulating portion 44, and additionally includes a transmission data generating portion 108, a transmission control portion 110, a reception control portion 112, a reception error rate detecting portion 114, and a reception signal strength detecting portion 116.

The transmission control portion 110 controls the transmission directivity i.e., the directivity of the transmission signals, by controlling the respective phases (and additionally the respective amplitudes, as needed) of the respective transmission signals to be transmitted by the plurality of transmission-reception antenna elements 20. More specifically described, the transmission control portion 110 controls the directivity control portion 102 to control the respective phases of the respective transmission signals and thereby controls, as a transmission phased array antenna, a transmission antenna constituted by the plurality of transmission-reception antenna elements 20. Alternatively, the transmission control portion 110 controls the directivity control portion 102 to control the respective phases and amplitudes of the respective transmission signals so as to improve a quality of the reception signal, and thereby controls, as a transmission adaptive array antenna, a transmission antenna constituted by the plurality of transmission-reception antenna elements 20. Preferably, the transmission control portion 110 determines the transmission directivity so that the reception signal synthesizing portion 42 may synthesize a maximum amount of the reception signals.

The reception control portion 112 controls the reception directivity, i.e., the directivity of the reception signals, by controlling the respective phases (and the respective amplitudes, as needed) of the respective reception signals received by the plurality of transmission-reception antenna elements 20. More specifically described, the reception control portion 112 controls the directivity control portion 102 to control the respective phases of the respective reception signals and thereby controls, as a reception phased array antenna, a reception antenna constituted by the plurality of transmission-reception antenna elements 20. Alternatively, the reception control portion 112 controls the directivity control portion 102 to control the respective phases and amplitudes of the respective reception signals so as to improve a quality of the reception signal, and thereby controls, as a reception adaptive array antenna, a reception antenna constituted by the plurality of transmission-reception antenna elements 20. Preferably, the reception control portion 112 determines the reception directivity so that the reception signal synthesizing portion 42 may synthesize a maximum amount of the reception signals.

The reception error rate detecting portion 114 functions as a sort of reception quality detecting portion that detects a quality of the reception signals received under the control of the reception control portion 112. The reception error rate detecting portion 114 detects, as the quality of reception signals, an error rate of the reception signals. Preferably, the detecting portion 114 detects a BER (bit error rate) or a FER (frame error rate) of the reception signals.

The reception signal strength detecting portion 116 functions as another sort of reception quality detecting portion that detects a quality of the reception signals received under the control of the reception control portion 112. The reception signal strength detecting portion 116 detects, as the quality of reception signals, a strength of the reception signals, i.e., an RSSI (received signal strength indicator).

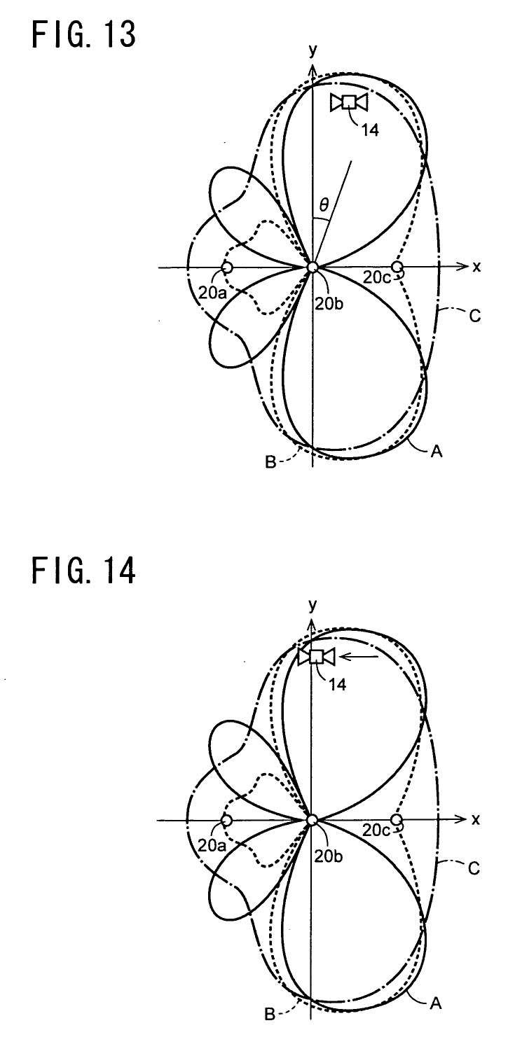

FIG. 13 is a view for explaining respective directivity patterns established under the respective controls of the transmission control portion 110 and the reception control portion 112. In the fourth embodiment, the three transmission-reception antenna elements 20a, 20b, 20c each as a bar-like array antenna such as a dipole antenna are located on a common plane (i.e., a plane perpendicular to a y axis shown in FIG. 13), such that the three antenna elements 20a, 20b, 20c extend parallel to each other and are equidistant from each other. FIG. 13 shows three sorts of directivity patterns each in the case where an angle, θ, of a directivity direction (i.e., a main-lobe direction) is 20 degrees. More specifically described, a thick solid line indicates a “narrow” directivity pattern, A, having a relatively small width or angle; a thick broken line indicates a directivity pattern, B, having a medium width or angle; and a thick one-dot chain line indicates a “broad”directivity pattern, C, having a relatively large width or angle. Thus, under the same directivity-direction angle θ, various directivity patterns having different shapes, different breadths of main lobe, different side or secondary lobes, and/or different null points may be established by each of the transmission control portion 110 and the reception control portion 112. Thus, each one of the transmission control portion 110 and the reception control portion 112 can establish the corresponding directivity pattern, based on the quality of reception signals, detected by the reception quality detecting portion 114, 116, independent of the other of the two control portions 110, 112.

FIG. 14 is a view for explaining a directivity pattern suitable for the case where the radio tag 14 as the communication destination is moving relative to the plurality of transmission-reception antenna elements 20. For example, in the case, shown in FIG. 14, where the radio tag 14 is moving relative to the antenna elements 20 in a direction parallel to the x axis, it is possible that while the above-described “narrow” directivity pattern A is used to transmit the transmission signal to the radio tag 14, the radio tag 14 may go out of the pattern A so as not to be able to receive a sufficient amount of electric power to return the return signal. However, if the transmission directivity and the reception directivity are both changed from the narrow directivity pattern A, to the above-described broader directivity pattern B or C, then the transmission-reception antenna elements 20 may become able to receive adversely noise (e.g., jamming) or a considerably strong return signal from another radio tag different from the radio tag 14 as the communication destination, which may lead to lowering the quality of the reception signals. Therefore, it is desirable to make only the transmission directivity broader while keeping the reception directivity narrow. Meanwhile, in the case where the radio tag 14 as the communication destination is moving relative to the plurality of transmission-reception antenna elements 20, an error rate of the reception signals tends to be considerably high whereas a strength of the reception signals tends to be considerably low. Hence, the transmission control portion 110 broadens the transmission directivity when the error rate of the reception signals, detected by the reception error rate detecting portion 114, is not smaller than a first predetermined value and the strength of the reception signals, detected by the reception signal strength detecting portion 116, is smaller than a second predetermined value.

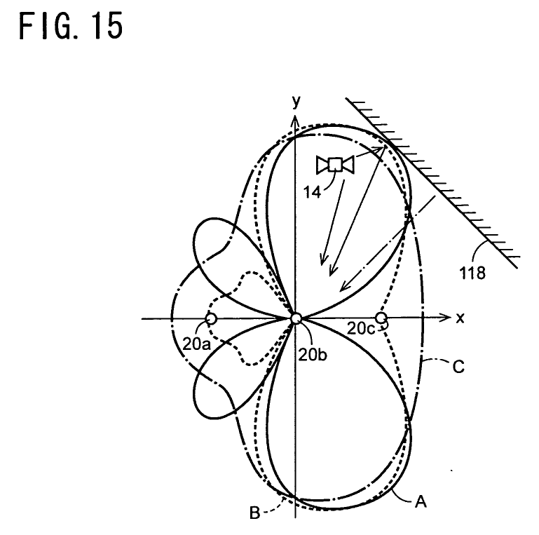

FIG. 15 is a view for explaining a directivity pattern suitable for the case where a reflector that can reflect the transmission signal or the return signal is present in the vicinity of the radio tag 14 as the communication destination. The reflector may be a wall 118, as shown in FIG. 15, that is fixed in position relative to the radio tag 14, or may be various moving objects such as a walking person or a moving cart carrying a burden. For example, in the case, shown in FIG. 15, where the wall 118 as the reflector that can reflect the transmission signal or the return signal is present in the vicinity of the radio tag 14 as the communication destination, it is possible that while the above-described “broad” directivity pattern C is used to transmit the transmission signal to the radio tag 14, the transmission signal may be reflected by the wall 118 and the transmission-reception antenna elements 20 may receive, as noise, the thus reflected signal, indicated by an arrow represented by a thin one-dot chain line in FIG. 15. However, if the transmission directivity and the reception directivity are both changed from the broad directivity pattern C to the above-described narrower directivity pattern B or A, then the transmission-reception antenna elements 20 may become unable to receive adversely the return signal from the radio tag 14, indicated by arrows represented by thin solid lines in FIG. 15, which may lead to lowering the quality of the reception signals. Therefore, it is desirable to make only the transmission directivity narrower while keeping the reception directivity broad. In the case where the reflector that can reflect the transmission signal or the return signal is present in the vicinity of the radio tag 14 as the communication destination, both the error rate and strength of the reception signals tend to be considerably high. Hence, the transmission control portion 110 narrows the transmission directivity when the error rate of the reception signals, detected by the reception error rate detecting portion 114, is not smaller than a third predetermined value and the strength of the reception signals, detected by the reception signal strength detecting portion 116, is not smaller than a fourth predetermined value.

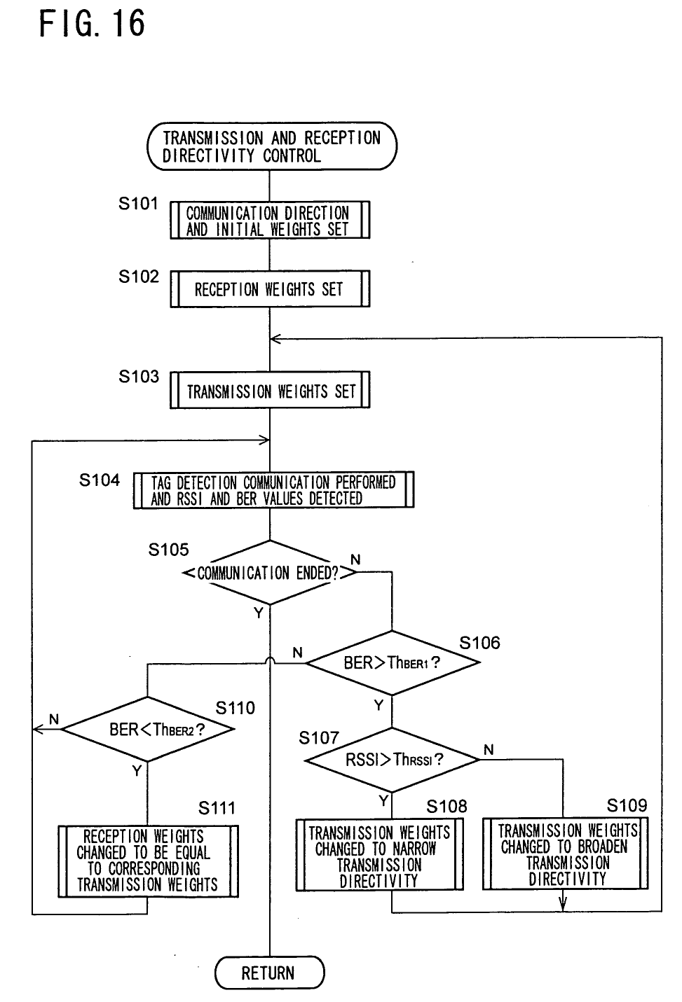

FIG. 16 is a flow chart representing a transmission-reception directivity control operation of the control device 32 of the radio tag communication apparatus 100. The transmission-reception directivity control is carried out between the radio tag communication apparatus 100 and the radio tag 14. The transmission-reception directivity control operation is repeated at a predetermined period or cycle time.

When the radio tag communication apparatus 100 starts communication with the radio tag 14, first, at Step S101, the control device 32 sets a directivity direction for the communication with the radio tag 14, and additionally sets initial weights common to signal transmission and signal reception. Then, at Step S102, the control device 32 controls the reception-signal phase control portions 34 and the reception-signal amplitude control portions 36 to control the respective phases and amplitudes of the reception signals and thereby set respective reception weights. Next, at Step S103, the control device 32 controls the transmission-signal phase control portions 104 and the transmission-signal amplitude control portions 106 to control the respective phases and amplitudes of the transmission signals and thereby set respective transmission weights. Then, at Step S104, the control device 32 performs a communication operation to detect the radio tag 14. More specifically described, the control device 32 synthesizes the respective reception signals received by the transmission-reception antenna elements 20, with each other, into a synthesized reception signal, and demodulates the thus synthesized reception signal. In addition, the control device 32 detects an error rate BER and a strength RSSI of the demodulated reception signal. Next, at Step S105, the control device 32 judges whether the communication with the radio tag 14 has ended. If a positive judgment is made at Step S105, then the current cycle of this routine is finished. On the other hand, if a negative judgment is made at Step S105, then the control of the control device goes to Step S106 to judge whether the error rate BER of the demodulated reception signal, detected at Step S104, is greater than a predetermined value, Th_{BER1}. If a negative judgment is made at Step S106, then the control of the control device goes to Step S10 to judge whether the error rate BER of the demodulated reception signal, detected at Step S104, is smaller than a predetermined value, Th_{BER2}. On the other hand, if a positive judgment is made at Step S106, then the control goes to Step S107 to judge whether the strength RSSI of the demodulated reception signal, detected at Step S104, is greater than a predetermined value, Th_{SRRI}. If a positive judgment is made at Step S107, then the control goes to Step S108 to control the transmission-signal phase control portions 104 and the transmission-signal amplitude control portions 106 to control the respective phases and amplitudes of the transmission signals, i.e., control the respective transmission weights to make the transmission directivity narrower. Then, the control returns to Step S103 and the following steps. On the other hand, if a negative judgment is made at Step S107, then the control goes to Step S109 to control the transmission-signal phase control portions 104 and the transmission-signal amplitude control portions 106 to control the respective phases and amplitudes of the transmission signals, i.e., control the respective transmission weights to make the transmission directivity broader. Then, the control returns to Step S103 and the following steps. Meanwhile, if a negative judgment is made at Step S110, then the control goes to Step S104 and the following steps. On the other hand, if a positive judgment is made at Step S110, then the control goes to Step S111 to control the reception-signal phase control portions 34 and the reception-signal amplitude control portions 36 to control the respective phases and amplitudes of the reception signals, i.e., control each of the respective reception weights to be equal to a corresponding one of the respective transmission weights. Then, the control returns to Step S104 and the following steps. Thus, in the present embodiment, Steps S101, S103, S104, S108, and S109 correspond to the operation of the transmission control portion 110; Step S101, S102, S104, and S111 correspond to the operation of the reception control portion 112; and Step S104 corresponds to the respective operations of the reception signal synthesizing portion 42, the reception signal demodulating portion 44, the reception error rate detecting portion 114, and the reception signal strength detecting portion 116.

As is apparent from the foregoing description of the fourth embodiment, the radio tag communication apparatus 100 includes the transmission control portion 110 (Steps S101, S103, S104, S108, and S109) that controls the transmission directivity by controlling the respective phases of the respective transmission signals to be transmitted by the transmission-reception antenna elements 20; the reception control portion 112 (Steps S101, S102, S104, and S111) that controls the reception directivity by controlling the respective phases of the respective reception signals received by the transmission-reception antenna elements 20; and the reception error rate detecting portion 114 and the reception signal strength detecting portion 116 each as the reception quality detecting portion that detects the quality of the reception signals controlled by the reception control portion 112, and at least one of the transmission control portion 110 and the reception control portion 112 controls, based on the reception signal quality values detected by the reception error rate detecting portion 114 and the reception signal strength detecting portion 116, a corresponding one of the transmission directivity and the reception directivity. In particular, the transmission control portion 110 and the reception control portion 112 control, based on the reception signal quality values detected by the reception error rate detecting portion 114 and the reception signal strength detecting portion 116, the transmission directivity and the reception directivity, respectively, independent of each other. Therefore, even in the case where the present radio tag communication apparatus 100 communicates information with the radio tag 14 that is moving relative to the apparatus 100, or even in the case there is a considerably strong return signal from another radio tag different from the radio tag 14 as the communication destination, the present apparatus 100 can control the transmission directivity and the reception directivity, independent of each other, and thereby perform good communication. Thus, the present radio tag communication apparatus 100 can well communicate with the radio tag 14 as the communication destination, irrespective of the relative-positional relationship between them or the communication environment around them.

In addition, the transmission control portion 110 can control the respective amplitudes of the respective transmission signals to be transmitted by the transmission-reception antenna elements 20, and the reception control portion 112 controls the respective amplitudes of the respective reception signals received by the transmission-reception antenna elements 20. Therefore, the transmission control portion 110 can reliably determine the transmission directivity and the reception control portion 112 can reliably determine the reception directivity.

In addition, all the transmission-reception antenna elements 20 are commonly used to transmit the respective transmission signals and receive the respective reception signals. Therefore, the size of the present radio tag communication apparatus 100 can be minimized.

In addition, the reception quality detecting portion comprises the reception error rate detecting portion 114 (Step S104) that detects, as the quality of the reception signals, the error rate of the demodulated reception signal. Therefore, the transmission directivity and/or the reception directivity can be controlled based on the error rate of the demodulated reception signal that indicates the presence of jamming wave or a reflector (e.g., a wall) in the communication environment.

In addition, the reception quality detecting portion comprises the reception signal strength detecting portion 116 (Step S104) that detects, as the quality of the reception signals, the strength of the demodulated reception signal. Therefore, the transmission directivity and/or the reception directivity can be controlled based on the strength of the demodulated reception signal that indicates the relative-positional relationship between the radio tag communication apparatus 100 and the radio rag 14 as the communication destination.

In addition, the transmission control portion 110 controls, when the error rate of the reception signals detected by the reception error rate detecting portion 114 is not smaller than a first predetermined value and the strength of the reception signals detected by the reception signal strength detecting portion 116 is smaller than a second predetermined value, the transmission directivity to be broader. Therefore, for example, in the case where the radio tag 14 as the communication destination is moving relative to the radio tag communication apparatus 100, the transmission directivity is broadened, i.e., the signal transmission range is broadened and accordingly a good communication is established between the two elements 100, 14.

In addition, the transmission control portion 110 controls, when the error rate of the reception signal detected by the reception error rate detecting portion 114 is not smaller than a third predetermined value and the strength of the reception signal detected by the reception signal strength detecting portion 116 is not smaller than a fourth predetermined value, the transmission directivity to be narrower. The third predetermined value may be equal to, or different from, the first predetermined value; and fourth predetermined value may be equal to, or different from, the second predetermined value. Therefore, for example, in the case where there is the reflection signal as the transmission signal reflected from the wall 118, the transmission directivity is narrowed, i.e., the signal transmission range is narrowed and accordingly a good communication is established between the two elements 100, 14.

In addition, the reception control portion 112 controls, when the error rate of the reception signals detected by the reception error rate detecting portion 114 is not greater than a fifth predetermined value, the reception directivity to be equal to the transmission directivity controlled by the transmission control portion 110. Since the transmission directivity optimized by the transmission control portion 110 can be utilized by the reception control portion 112, a good communication is established between the two elements 100, 14.

While the present invention has been described in its preferred embodiments by reference to the drawings, it is to be understood that the invention may otherwise be embodied.

For example, in the illustrated embodiments, each of the transmission antenna selection control portion 40, the reception signal synthesizing portion 42, the reception signal demodulating portion 44, the reception directivity control portion 46, the position detecting portion 48, the transmission control portion 110, the reception control portion 112, the reception error rate detecting portion 114, and the reception signal strength detecting portion 116 is provided as a control function or capability of the control device 32. However, all those portions 40 through 48, 110 through 116 may be provided as individual control devices. Each of those control functions or capabilities of the control device 32 may be established by processing either digital signals or analog signals.

In the illustrated embodiments, each of the radio tag communication apparatuses 12, 100 employs the plurality of transmission-reception antenna elements 20 each of which transmits the transmission signal toward the radio tag 14 and receives the return signal returned by the radio tag 14 in response to the transmission signal. However, each radio tag communication apparatus 12, 100 may employ a plurality of transmission antenna elements each of which transmits the transmission signal toward the radio tag 14, and additionally employ a plurality of reception antenna elements each of which receives the return signal returned by the radio tag 14 in response to the transmission signal. Alternatively, a portion of the plurality of transmission antenna elements and a portion of the plurality of reception antenna elements may be replaced with one or more transmission-reception antenna elements 20. If at least one of the plurality of transmission antenna elements and at least one of the plurality of reception antenna elements is replaced with at least one transmission-reception antenna element 20, the size of each radio tag communication apparatus 12, 100 can be reduced.

In the fourth embodiment, the transmission control portion 110 controls the transmission directivity by controlling the respective phases and respective amplitudes of the respective transmission signals to be transmitted by the transmission-reception antenna elements 20. However, the transmission control portion 110 may be modified to control the transmission directivity by controlling only the respective phases of the transmission signals. Likewise, the reception control portion 112 may be modified to control the reception directivity by controlling only the respective phases of the reception signals.

The present invention may be embodied with various changes and improvements that may occur to a person skilled in the art, without departing from the scope and spirit of the invention.

What is claimed is:

1. A radio tag communication apparatus for communicating information with a radio tag, comprising:
a plurality of transmission antenna elements which transmit a transmission signal toward the radio tag;
a plurality of reception antenna elements each of which receives, as a reception signal, a return signal returned by the radio tag in response to the transmission signal;
a transmission antenna selection control portion which selects one of the transmission antenna elements so that the selected one transmission antenna element transmits the transmission signal toward the radio tag; and
a reception signal synthesizing portion which synthesizes the respective reception signals received by the reception antenna elements, with each other.

2. The radio tag communication apparatus according to claim 1, further comprising a phased array control portion which determines a reception directivity by controlling respective phases of the respective reception signals received by the reception antenna elements.

3. The radio tag communication apparatus according to claim 2, wherein the transmission antenna selection control portion selects said one transmission antenna element according to the reception directivity determined by the phased array control portion.

4. The radio tag communication apparatus according to claim 1, further comprising an adaptive array control portion which controls respective weights given to the respective reception signals received by the reception antenna elements.

5. The radio tag communication apparatus according to claim 4, wherein the adaptive array control portion determines, according to said one transmission antenna element selected by the transmission antenna selection control portion, respective initial values of the respective weights given to the respective reception signals received by the reception antenna elements.

6. The radio tag communication apparatus according to claim 1, wherein the reception signal synthesizing portion selectively synthesizes the respective reception signals received by the reception antenna elements, with each other.

7. The radio tag communication apparatus according to claim 1, further comprising a position detecting portion which detects, based on an amount of the reception signals synthesized by the reception signal synthesizing portion, a position of the radio tag as a communication target.

8. The radio tag communication apparatus according to claim 1, wherein the plurality of transmission antenna elements and the plurality of reception antenna elements comprise a plurality of transmission and reception antenna elements which transmit the transmission signal toward the radio tag and each of which receives, as the reception signal, the return signal returned by the radio tag in response to the transmission signal.

9. The radio tag communication apparatus according to claim 8, wherein the transmission antenna selection control portion selects one of the transmission and reception antenna elements so that the selected one transmission and reception antenna element transmits the transmission signal, and wherein the reception signal synthesizing portion synthesizes the respective reception signals received by said one transmission and reception antenna element selected by the transmission antenna selection control portion and at least one of the other transmission and reception antenna elements that is located within a first predetermined distance range from said one transmission and reception antenna element.

10. The radio tag communication apparatus according to claim 8, wherein the transmission antenna selection control portion selects one of the transmission and reception antenna elements so that the selected one transmission and reception antenna element transmits the transmission signal, and wherein the reception signal synthesizing portion synthesizes the respective reception signals received by not said one transmission and reception antenna element selected by the transmission antenna selection control portion but two or more of the other transmission and reception antenna elements that are located within a second predetermined distance range from said one transmission and reception antenna element.

11. A radio tag communication apparatus for communicating information with a radio tag, comprising:
a plurality of transmission antenna elements which transmit respective transmission signals toward the radio tag;
a plurality of reception antenna elements each of which receives, as a reception signal, a return signal returned by the radio tag in response to at least one of the transmission signals;
a transmission control portion which controls a transmission directivity by controlling respective phases of the respective transmission signals to be transmitted by the transmission antenna elements;
a reception control portion which controls a reception directivity by controlling respective phases of the respective reception signals received by the reception antenna elements; and
a reception quality detecting portion which detects a quality of the reception signals controlled by the reception control portion,
wherein at least one of the transmission control portion and the reception control portion controls, based on the quality of the reception signals detected by the reception quality detecting portion, a corresponding one of the transmission directivity and the reception directivity.

12. The radio tag communication apparatus according to claim 11, wherein the transmission control portion and the reception control portion control, based on the quality of the reception signals detected by the reception quality detecting portion, the transmission directivity and the reception directivity, respectively, independent of each other.

13. The radio tag communication apparatus according to claim 11, wherein the transmission control portion controls the transmission directivity by controlling respective amplitudes of the respective transmission signals to be transmitted by the transmission antenna elements, and the reception control portion controls the reception directivity by controlling respective amplitudes of the respective reception signals received by the reception antenna elements.

14. The radio tag communication apparatus according to claim 11, wherein the transmission antenna elements and the reception antenna elements comprise at least one transmission and reception antenna element which transmits a transmission signal toward the radio tag and receives, as a reception signal, a return signal returned by the radio tag.

15. The radio tag communication apparatus according to claim 11, wherein the transmission antenna elements and the reception antenna elements consist of a plurality of transmission and reception antenna elements each of which transmits a transmission signal toward the radio tag and receives, as a reception signal, a return signal returned by the radio tag.

16. The radio tag communication apparatus according to claim 11, wherein the reception quality detecting portion detects, as the quality of the reception signals, an error rate of the reception signals.

17. The radio tag communication apparatus according to claim 11, wherein the reception quality detecting portion detects, as the quality of the reception signals, a strength of the reception signals.

18. The radio tag communication apparatus according to claim 17, wherein the reception quality detecting portion further detects, as the quality of the reception signals, an error rate of the reception signals, and wherein the transmission control portion controls, when the error rate of the reception signals detected by the reception quality detecting portion is not smaller than a first predetermined value and the strength of the reception signals detected by the reception quality detecting portion is smaller than a second predetermined value, the transmission directivity to be broader.

19. The radio tag communication apparatus according to claim 17, wherein the reception quality detecting portion further detects, as the quality of the reception signals, an error rate of the reception signals, and wherein the transmission control portion controls, when the error rate of the reception signals detected by the reception quality detecting portion is not smaller than a third predetermined value and the strength of the reception signals detected by the reception quality detecting portion is not smaller than a fourth predetermined value, the transmission directivity to be narrower.

20. The radio tag communication apparatus according to claim 16, wherein the reception control portion controls, when the error rate of the reception signals detected by the reception quality detecting portion is not greater than a fifth predetermined value, the reception directivity to be equal to the transmission directivity controlled by the transmission control portion.
